(19) United States
(12) Patent Application Publication
(10) Pub. No.: US 2012/0037614 A1
(43) Pub. Date: Feb. 16, 2012

(54) INDUCTION HEATING COOKER

(75) Inventors: Hirofumi Komoto, Hyogo (JP); Kenji Watanabe, Nara (JP); Shintaro Noguchi, Hyogo (JP)

(73) Assignee: PANASONIC CORPORATION, Kadoma-shi, Osaka (JP)

(21) Appl. No.: 13/264,685

(22) PCT Filed: Feb. 25, 2010
(86) PCT No.: PCT/JP2010/001264

§ 371 Date: Oct. 14, 2011

(30) Foreign Application Priority Data
Apr. 23, 2009 (JP) 2009-104977

(51) Int. Cl. H05B 6/12

(52) U.S. Cl. 219/622

(57) ABSTRACT

An induction heating cooker including a heating coil, a top plate, an inverter circuit, a temperature sensor provided under the top plate and detecting a bottom temperature of the pot load, an inverter circuit for supplying a high frequency current to the heating coil, a temperature calculating part for calculating the bottom temperature of the pot load based on an output of the temperature sensor, a setting part for a user to set a cooking temperature freely therewith, a controller for controlling an output of the inverter circuit make the bottom temperature of the pot load calculated by the temperature calculating part match the cooking temperature, a cumulative electric power measuring part for measuring a cumulative electric power value of an electric power supplied to the pot load during a second predetermined time period at intervals of a first predetermined time period, and a adjusting part adjusting the cooking temperature to a higher temperature by a second predetermined value when an increased amount of the cumulative electric power value as compared to another cumulative electric power value measured before a third predetermined time period is larger than a first predetermined value.

### TECHNICAL FIELD

This invention relates to an induction heating cooker having a temperature sensor and is used for an ordinary household, a restaurant and an office.

### BACKGROUND ART

In recent years, a fine cooking quality is realized with an induction heating cooker having a good heat response, laying out a temperature sensor element near a pot as a load, detecting a temperature of the pot or the like and adjusting heat to the load. Since induction heating cooker does not use flame for heating, it does not contaminate air of a room therefore is safe and clean. This characteristic attracts market attention, and demand for the cooker is rapidly growing.

An conventional induction heating cooker is explained using drawings. FIG. 3 is a block diagram of the conventional induction heating cooker.

As in FIG. 3, pot load 101 is placed on top plate 102. Heating coil 103 heats up pot load 101. Temperature sensor 105 is provided underside of top plate 102 for detecting a temperature of pot load 101 through top plate 102. Temperature calculating part 106 calculates the temperature of pot load 101 based on an output of temperature sensor 105. A user sets a cooking temperature freely with setting part 108. Controller 107 controls an output of inverter circuit 104 such that the temperature of pot load 101 calculated by temperature calculating part 106 may match the cooking temperature set by setting part 108.

In above structured induction heating cooker, the temperature of pot load 101 calculated by temperature calculating part 106 and the cooking temperature set by the user with setting part 108 are compared. Controller 7 then controls the output of inverter circuit 104 and determine an electric power to be input to pot load 101. The output of inverter circuit 104 is automatically adjusted so that a cooking temperature of pot load 101 becomes equal to the user set temperature, thus an automatic temperature adjustment function is realized.

With the conventional induction heating cooker thus structured, the temperature of pot load 101 calculated by temperature calculating part 106 and the cooking temperature set by the user with setting part 108 are compared to determine the electric power input to pot load 101. However, when the temperature of a bottom part of pot load 101 heated by induction heating cooker and a temperature of cooking item such as tempura oil (deep frying oil) in the pot are compared, the temperature of the bottom part of pot load 101 heated by induction heating cooker tends to become higher. This tendency becomes more distinctive as the electric power input to pot load 101 is higher.

In other words, when the electric power input to pot load 101 is low, a difference in temperature between the bottom part of pot load 101 and the cooking item is small and the temperature of the bottom part of pot load 101 and that of the cooking item tend to conform. In actual cooking situation, however, when a load is applied, an inside temperature of pot load 101 falls down, reducing an output from temperature sensor 105. If a power input to pot load 101 is raised to increase the temperature of induction heating, a change occurs between the temperature of the bottom part of pot load 101 and the cooking item and the difference becomes larger. Namely the temperature of the bottom part of pot load 101 becomes higher while the temperature of the cooking item stays low. The temperature of the cooking item is thus stabilized at a lower temperature, not returning to the temperature the user set. Thus, a stable cooking quality is not achieved, leaving a problem.

In order to solve above problem, the conventional induction heating cooker described in patent literature 1 has a cumulative electric power measuring part for measuring a cumulative electric power value supplied to pot load 101 during a past predetermined time period. When the cumulative electric power value measured by the cumulative electric power measuring part is larger than a predetermined value, the power input is corrected so that the temperature is raised by a predetermined value from the temperature set by setting part 108.

However, with the art described in patent literature 1, the inducting heating cooker is unable to detect whether or not a cooking item is put in pod load 101 until the cumulative electric power measuring part determines that the cumulative electric power value has increased by the predetermined value. The cumulative electric power value does not increase fast but increases slowly with a moderate slope, so that when an average electric power input is low before the cooking item is put in pot load 101, time required from the cooking item is placed in pot load 101 till the cumulative electric power value reaches the predetermined value becomes longer, that the cooker is unable to detect quickly that the cooking item has been put in pot load 101, leaving another problem.

Further, the average electric power input immediately before a cooking item is put in pot load 101 is varied, so depending on a condition of the cooking item such as an amount of the item, there is a possibility a wrong determination is made that a cooking item has been placed in pot load 101 even when the cooking condition is stabilized. Still further, since it is necessary to make a detection sensibly that a cooking item has been put in pot load 101, the predetermined value of the cumulative electric power value cannot be set too low, leaving still other problems.

PTL 1: Unexamined Japanese Patent Publication No. H9-140575.

### SUMMARY OF THE INVENTION

An induction heating cooker including a heating coil for heating a pot load, a top plate for carrying the pot load above an upper part of the heating coil, an inverter circuit for supplying a high frequency current to the heating coil, a temperature sensor provided under the top plate and for detecting a bottom temperature of the pot load, a temperature calculating part for calculating the bottom temperature of the pot load based on an output of the temperature sensor, a setting part for a user to set cooking temperature freely therewith, a controller for controlling an output of the inverter circuit to make the bottom temperature of the pot load calculated by the temperature calculating part match the cooking temperature, a cumulative electric power measuring part for measuring a cumulative electric power value of electric power supplied to the pot load during a second predetermined time period, and a adjusting part for adjusting the cooking temperature to a higher temperature by a second predetermined value when an increased amount of the cumulative electric power value as compared to another cumulative electric power value measured before a third predetermined time period is larger than a first predetermined value.

The temperature sensor of induction heating cooker thus structured detects the bottom temperature of the pot load. Therefore, when an electric power supplied to the pot load is large and the bottom temperature of the pot load is higher than a temperature of a cooking item, the temperature sensor measures a higher temperature than an actual temperature of the cooking item. The induction heating cooker of the present invention detects that a cooking item has been put in when the cumulative electric power value for a second predetermined time period becomes larger than an increased amount of a cumulative electric power value measured immediately before the third predetermined time period. Adjusting part makes an adjustment so that the cooking temperature of the cooking becomes higher than the temperature the user has set. Resultantly, as an additional load is applied to where the temperature of cooking item is stabilized, the temperature of the cooking item quickly returns to what the user set and which temperature is maintained.

### BRIEF DESCRIPTION OF THE DRAWINGS

FIG. 1 is a block diagram of an induction heating cooker according to a preferred embodiment of the present invention.

FIG. 2 illustrates a measuring method of a cumulative electric power with a cumulative electric power measuring part of the induction heating cooker and a measuring method of an increased amount of the cumulative electric power with an adjusting part thereof according to a preferred embodiment of the present invention.

FIG. 3 is a block diagram of a conventional induction heating cooker.

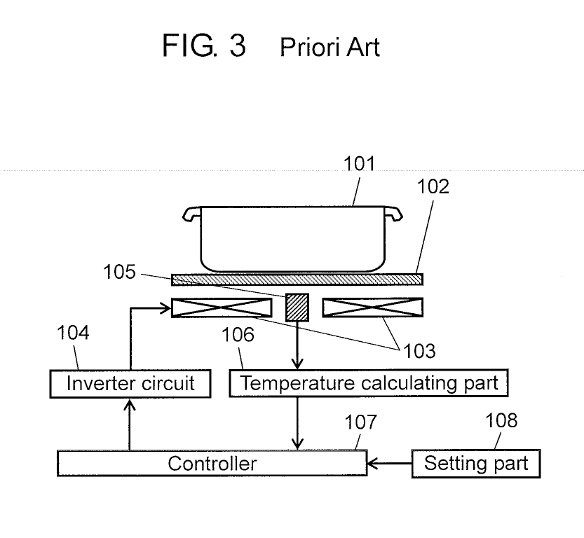

### DETAILED DESCRIPTION OF THE PREFERRED EMBODIMENTS

Following, a preferred exemplary embodiment of the present invention is explained referring to the drawings. A scope of the invention is not necessarily limited by the exemplary embodiments.

### EXEMPLARY EMBODIMENTS

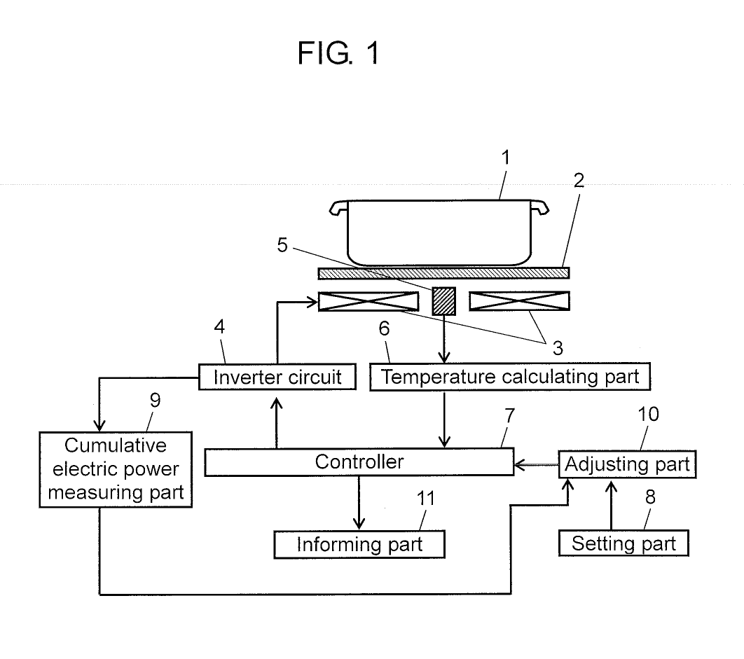

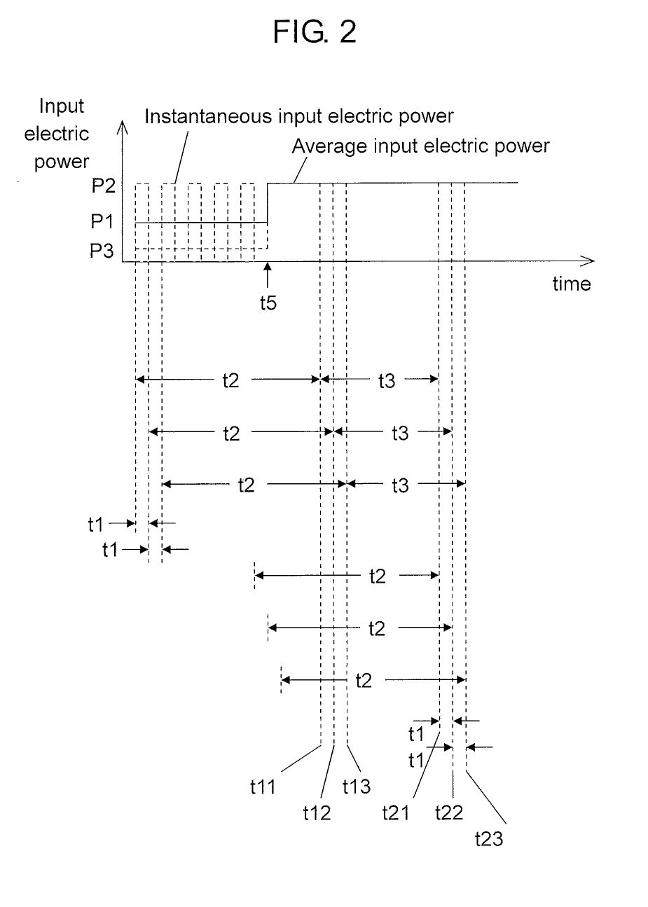

FIG. 1 is a block diagram of an induction heating cooker according to a preferred embodiment of the present invention. FIG. 2 illustrates a measuring method of a cumulative electric power with a cumulative electric power measuring part of the induction heating cooker and a measuring method of an increased amount of the cumulative electric power with an adjusting part thereof according to a preferred embodiment of the present invention.

In the induction heating cooker in FIG. 1, pot load 1 is placed on top plate 2. Heating coil 3 is provided on a lower side of top plate 2 for heating pot load 1. Temperature sensor 5 is provided on a lower side of top plate 2 for detecting bottom temperature T of pot load 1 through top plate 2. Temperature sensor 5 is composed of a thermal element such as a thermistor and an infrared sensor for detecting radiated energy from pot load 1. When a thermal element is employed, temperature sensor 5 is disposed in a place so that it contacts a rear surface of top plate 2. When an infrared sensor is employed, top plate 2 is composed of an optically transparent material, and temperature sensor 5 is disposed below top plate 2 for detecting an infrared ray radiated from a bottom of pot load 1 through top plate 2. Temperature calculating part 6 calculates the bottom temperature T of pot load 1 based on an output from temperature sensor 5. A user may set cooking temperature T1 freely with setting part 8. Controller 7 controls an output of inverter circuit 4 by controlling on-time of a switching element (not illustrated) of inverter circuit 4, so that the bottom temperature T of pot load 1 calculated by temperature calculating part 6 matches cooking temperature T1 set by setting part T1. Inverter circuit 4 supplies a high frequency current to heating coil 3 for heating pot load 1.

FIG. 2 shows that cumulative electric power measuring part 9 integrates every first predetermined time period t1 (1 sec, for instance) an instantaneous electric power (hereinafter, it may be simply called electric power) supplied by inverter circuit 4 to pot load 1 at time t11 to t13 and t21 to t23 for past second predetermined time period t2 (30 sec, for instance). To simplify, an input voltage may be regarded constant and an input current to inverter circuit 4 may be integrated in place of electric power value W. Namely, cumulative electric power value W may not have to be an integrated input electric power value but it may be a cumulative input current value as it corresponds to cumulative electric power value W.

Adjusting part 10 adjusts cooking temperature T1 which is produced by cumulative electric power W and measured by cumulative electric power measuring part 9 at t21 to t23 every predetermined time period t1 to a temperature which is higher by second predetermined value ΔT1 before third predetermined time period t3 (for instance 20 sec) starts. Namely, when increased amount ΔW from cumulative electric power value W (ΔW=W−W1) measured at time t11 to t13 (hereinafter, called increased amount ΔW of cumulative electric power value W, or increased amount ΔW) is larger than first predetermined value ΔW1, adjusting part 10 adjusts cooking temperature T1 to higher temperature by second predetermined value ΔT1. Here, first predetermined value ΔW1 is a threshold value to be compared with increased amount ΔW to determine whether a cooking item is put in the cooking pot or not, and which is 7000 W sec, for instance. Second predetermined value ΔT1 is a temperature to compensate cooking temperature T1, and which is 10° C. to 15° C., for instance.

The 7000 W sec quoted in above as first predetermined value ΔW1 is calculated by “an average output difference (500 W) between a stabilized time and when a cooking item is put in×third predetermined time period t3 (20 sec)×a factor (0.7)”. This value may be appropriated with an experiment. When third predetermined time period t3 is made longer, an unwanted overheat may arise during measurement, and when it is made short, increased amount ΔW may remain small, reducing a discriminating precision. Third predetermined time period t3 as well as first predetermined time period t1 and second predetermined time period t2 may be appropriated with an experiment for a convenient usage.

An operational principle of above structure is explained next. As a user switches on setting part 8, setting part 8 outputs signals to controller 7, a signal for selecting a temperature control mode with which bottom temperature T of pot load 1 is automatically selected, a signal for selecting cooking temperature T1, and a signal for starting operation. Upon receipt of these signals, controller 7 drives inverter circuit 4, have it supply a high frequency current to heating coil 3 to heat pot load 1. An output from inverter 4 is s 1 kW, for instance. Temperature sensor 5 is placed on an undersurface of top plate 2 if the sensor is a thermal element or is placed below top plate 2 if the sensor is an infrared sensor, so the sensor detects the bottom temperature T of pot load 1 at a lower side of top plate 2. Temperature calculating part 6 calculates bottom temperature T of pot load 1 based on an output from temperature sensor 5. Controller 7 controls an output of inverter circuit 4 and supplies a proper amount of high frequency current to heating coil 3 such that the bottom temperature T of pot load 1 calculated by temperature calculating part 6 may match cooking temperature T1 the user set with setting part 8.

When cooking temperature T1 set by the user with setting part 8 is higher than bottom temperature T of pot load 1 calculated by temperature calculating part 6 (T1>T), controller 7 raises an output of inverter circuit 4 to raise bottom temperature T of pot load 1. Conversely, when cooking temperature Ti set by the user with setting part 8 is lower than bottom temperature T of pot load 1 calculated by temperature calculating part 6 (T1<T), controller 7 reduces the output of inverter circuit 4 or stops heating to lower bottom temperature T of pot load 1.

During time period t5 in FIG. 2, before cooking item is put in pot load 1, bottom temperature T of pot load 1 is matched with cooking temperature Ti and they are stabilized. At this time period, the induction heating cooker is repeating heating and non-heating cycles or periodically reducing the power output so that average power P1 is maintained. During t5, bottom temperature T of pot load 1 falls down as soon as a cooking item is put in, so that the input electric power is continuously supplied to keep average electric power P2 higher than P1. However, when bottom temperature T of pot load 1 is stably matched with cooking temperature T1, the average input power may fall down to P3, lower than P1 depending on the cooking item in pot load 1.

Cumulative electric power measuring part 9 integrates every first predetermined time period t1 the power which inverter circuit 4 supplied to pot load 1 during second predetermined time period t2. Adjusting part 10 adjusts cooking temperature T1 the user set with setting part 8 corresponding to increase amount ΔW of cumulative electric power value W.

For an example, when bottom temperature T of pot load 1 is stably controlled to a certain cooking temperature T1, bottom temperature T of pot load 1 falls down as soon as a cooking item is put in. Controller 7 then increases an output from inverter circuit 4 for raising bottom temperature T of pot load 1. At this time, since the output power of inverter circuit 4 is raised to increase bottom temperature T of pot load 1, increased amount ΔW of cumulative electric power value W becomes larger than before the cooking item is put in the pot. When increased amount ΔW of cumulative electric power value W exceeds first predetermined value ΔW1 (ΔW>ΔW1), adjusting part 10 adjusts cooking temperature T1 which the user set with setting part 8 to T132 T1+ΔT1 (ΔT1>0). Bottom temperature T is usually a highest temperature in pot load 1.

When a temperature of the cooking item is stabilized and a difference between the cooking item and bottom temperature T is not large, controller 7 controls an output of inverter circuit 4 so as bottom temperature T to match cooking temperature T1 set with setting part 8. Immediately after a cooking item is put in pot load 1, the electric power input to pot load 1 does not produce cooking temperature T1 set by setting part 8, even when bottom temperature T of pot load 1 is matched with cooking temperature T1 set by setting part 8. Bottom temperature T is therefore stabilized at a lower temperature than cooking temperature T1, degrading a finish of cooking. However, with the induction heating cooker according to the exemplary embodiment, adjustment is made to cooking temperature T1 as described, preventing degraded finish of cooking.

Thus, cooking temperature T1 set by the user with the setting part 8 is adjusted to T1+ΔT1. Controller 7 therefore adjusts an output of inverter circuit 4 so as the bottom temperature T of pot load 1 to match with the cooking temperature T1+ΔT after adjustment. Hence, when bottom temperature T of pot load 1 matches cooking temperature T1+ΔT1, the temperature of the cooking item put in pot load 1 is then close to cooking temperature T1 the user set with setting part 8, thus an automatic temperature control is realized, in which an electric power input to pot load 1 produces a temperature close to T1 set up by the user.

The present invention uses an increased amount ΔW of cumulative electric power value W to detect that a cooking item has been put in pot load 1, making a sensitive detection possible. Hence, compared with the conventional method (patent document 1) which detects cumulative power value W gradually increasing and exceeding a predetermined value, the present invention adjusts cooking temperature T1 much faster and stably.

Once adjusting part 10 starts adjustment of cooking temperature T1 the user set with setting part 8, such adjustment continues until fourth predetermined time period t4 is over. Here, predetermined time period t4 is a period from a time a cooking item is put in pot load 1 until the temperature of the cooking item reaches bottom temperature T of pot load 1, 10 minutes for instance. With this arrangement, the adjustment continues at least for fourth predetermined time period t4 unless the adjustment is cancelled by some adjustment cancelling function. This arrangement prevents a temperature of the cooking item to drop immediately after the cooking item is put in, preventing cooking quality to degrade. Even if the adjustment cancelling function does not work, the adjustment is cancelled when fourth predetermined time period t4 is over, avoiding a high cooking temperature Ti to continue for unnecessary a long period of time, thus safety is assured.

Further, adjusting part 10 cancels the adjustment when increased amount ΔW of cumulative electric power value W is less than third predetermined value ΔW2. Here, third predetermined value ΔW2 is a predetermined value settled corresponding to increased amount ΔW of cumulative electric power value W a threshold value on which to determine whether cooking temperature T1 needs an adjustment or not. For instance, when an output of inverter 4 is 1 kW, ΔW2 is 3500 W sec. For an example, when a cooking item is put in pot load 1 and a cooking temperature set by a user with setting part 8 is adjusted to T1+ΔT1, controller 7 raises a power output of inverter circuit 4 till bottom temperature T of pot load 1 becomes temperature T1+ΔT1. As it continues for a certain period of time, bottom temperature T of pot load 1 becomes T1+ΔT1, and then controller 7 reduces the output of inverter circuit 4.

Then, increased amount ΔW of cumulative electric power value W becomes small. When increased amount ΔW of cumulative electric power value W becomes lower than third predetermined value ΔW2 (ΔW<ΔW2), following situation occurs. The cooking temperature set by the user with setting part 8 has been adjusted to T1+ΔT1, but the adjustment is cancelled and now the temperature returns to the cooing temperature T1 the user set with setting part 8. This arrangement prevents the cooking item to be exposed to temperature T1+ΔT1 for an unnecessary a long period of time when cooking is consecutive. It also prevents adjustment from being carelessly cancelled.

First predetermined value ΔW1 as the threshold value at which cooking temperature T1 goes into adjustment and third predetermined value ΔW2 as the threshold value at which the adjustment is cancelled are set individually and third predetermined value ΔW2 lower than first predetermined value ΔW1. By setting the threshold value lower, an ample time is allowed to assure completion of cooking before the adjustment is cancelled.

Further, such arrangement prevents cumulative electric power value W measured by cumulative electric power measuring part 9 to fluctuate with noise or to operate unstably at around first predetermined value ΔW1 and third predetermined value ΔW2.

Where cooking temperature T1 originally set by the user with setting part 8 is adjusted to T1+ΔT1 by adjusting part 10, above mentioned adjustment cancelling function is not the only one to return the adjusted cooking temperature back to T1. Instead of or in addition to the adjustment cancelling function using third predetermined value ΔW2, adjusting part 10 can cancel the adjustment when electric power value W becomes lower than third predetermined value W2. With this arrangement, it becomes possible to make sure that the adjustment became certainly unnecessary.

Informing part 11 informs the user that adjusting part 10 has functioned right, letting the user continue cooking without anxiety. The user understands that bottom temperature T of pot load 1, even though it temporarily falls when a cooking item put in the pot, is rapidly recovering as the adjustment is working. Informing part 11 is composed of a light-emitting element, a piezoelectric element or the like.

As described, with the exemplary embodiment of the present invention, even when a temperature of the cooking item falls down with a load put in, user set cooking temperature T1 is adjusted corresponding to increased amount ΔW of cumulative electric power value W input to pot load 1 during second predetermined time period t2 and every first predetermined time period t1. Accordingly, a temperature of a cooking item is rapidly returned to the set temperature. Thus, an automatic temperature control is realized in which a cooking temperature immediately after a cooking item is put in matches the temperature the user set.

### INDUSTRIAL APPLICABILITY

The invention is composed of a system using a microcomputer; the invention is applicable to an induction heating cooker automatically and continually controlling a temperature of a cooking item to match a temperature set by user.

### REFERENCE MARKS IN THE DRAWINGS

1 pot load

2 top plate

3 heating coil

4 inverter circuit

5 temperature sensor

6 temperature calculating part

7 controller

8 setting part

9 cumulative electric power measuring part

10 adjusting part

11 informing part

1. An induction heating cooker comprising:
a heating coil for heating a pot load;
a top plate for carrying the pot load above an upper part of the heating coil;
an inverter circuit for supplying a high frequency current to the heating coil;
a temperature sensor provided under the top plate for detecting a bottom temperature of the pot load;
a temperature calculating part for calculating the bottom temperature of the pot load based on an output of the temperature sensor;
a setting part for a user to set a cooking temperature freely therewith;
a controller for controlling an output of the inverter circuit to make the bottom temperature of the pot load calculated by the temperature calculating part match the cooking temperature;
a cumulative electric power measuring part for measuring a cumulative electric power value of electric power supplied to the pot load during a second predetermined time period at intervals of a first predetermined time period; and
an adjusting part for adjusting the cooking temperature to a higher temperature by a second predetermined value when an increased amount of the cumulative electric power value as compared to another cumulative electric power value measured before a third predetermined time period is larger than a first predetermined value.

2. An induction heating cooker as listed in claim 1, wherein the adjusting part continued to perform adjustment for a fourth predetermined time period once the adjustment is started.

3. An induction heating cooker as listed in claim 1, wherein the adjusting part terminates the adjustment when the increased amount of the cumulative electric power value becomes smaller than a third predetermined value while performing the adjustment.

4. An induction heating cooker as listed in claim 3, wherein the adjusting part sets the third predetermined value lower than the first predetermined value.

5. An induction heating cooker as listed in claim 1, wherein the adjusting part terminates the adjustment when the cumulative electric power value becomes smaller than a fourth predetermined value while performing the adjustment.

6. An induction heating cooker as listed in claim 1, further comprising an informing part for informing the start of adjustment.

7. An induction heating cooker as listed in claim 2, wherein the adjusting part terminates the adjustment when the increased amount of the cumulative electric power value becomes smaller than a third predetermined value while performing the adjustment.

8. An induction heating cooker as listed in claim 2, wherein the adjusting part terminates the adjustment when the cumulative electric power value becomes smaller than a fourth predetermined value while performing the adjustment.
